(19) United States
(12) Patent Application Publication
(10) Pub. No.: US 2012/0294537 A1
(43) Pub. Date: Nov. 22, 2012

(54) SYSTEM FOR USING IMAGE ALIGNMENT TO MAP OBJECTS ACROSS DISPARATE IMAGES

(75) Inventors: Ira Wallace, Narberth, PA (US); Dan Caligor, New York, NY (US)

(73) Assignee: EyeIC, Inc., West Conshohocken, PA (US)

(21) Appl. No.: 13/501,637

(22) PCT Filed: May 1, 2009
(86) PCT No.: PCT/US09/42563

§ 371 Date: Jul. 6, 2012

Related U.S. Application Data
(60) Provisional application No. 61/049,954, filed on May 2, 2008.

(51) Int. Cl. G06K 9/46

(52) U.S. Cl. 382/201

(57) ABSTRACT

A method for mapping images having a common landmark or common reference point, in order to enable the creation, location and/or mapping of pixels, coordinates, markings, cursors, text and/or annotations across the images The method includes selecting at least two images having the common landmark or common reference point, mapping the selected images so as to generate mapping parameters that map a first location on a first image to the corresponding location of the first location on a second image, and identifying at least one pixel on the first image and applying the mapping parameters to the at least one pixel on the first image to identify the corresponding pixel or pixels in the second image The mapping parameters then may be used to locate or reproduce any pixels, coordinates, markings, cursors, text and/or annotations of the first image at the corresponding location of the second image.

### PRIORITY

This application claims priority to U.S. Provisional Patent Application, Ser. No. 61/049,954 filed May 2, 2008 and which is hereby incorporated in its entirety by reference.

### FIELD OF THE INVENTION

The invention relates to a system and method for mapping still or moving images of different types and/or different views of a scene or object at the same or different points in time such that a specific object or location in the scene may be identified and tracked in the respective images. The system and method may be applied to virtually any current or future image types, both 2-D and 3-D, both single-frame and multi-frame (video). The system and method also may be used in association with any known method of image alignment by applying the same form of transformation to images as applied by that image alignment method.

### BACKGROUND OF THE INVENTION

There are many instances where it is necessary to precisely pinpoint a specific location in one image within another, different image of the same subject matter. These images may be different types (e.g., x-ray, photograph, line drawing, map, satellite image, etc.), similar image types taken from different perspectives (e.g., different camera angle, rotation, focal length or subject-focal plane relationship), similar or different images taken at different points in time, or a combination of all of these. The techniques described herein may be used with such imaging types or other imaging types that capture and present images of 3-D space (e.g., CAT and MRI, which use multiple 2-D slices) or that create 3-D renderings from 2-D images (e.g., stereoscopic slides such as are used in the current ophthalmology image comparison gold standard or “3-D” technologies such as used in entertainment today). The image types may also include video and film, which are composed of individual images (2-D or stereoscopic).

Today, the options for achieving this mapping of such images are limited. A user may (1) estimate using various visual and intuitive techniques, (2) estimate using mathematical techniques, or (3) use computer image morphing techniques to align and overlay the images using, e.g., flicker chronoscopy, which is used in many other disciplines such as engineering and astronomy to identify change or motion. Each of these techniques has important shortcomings, including relatively low accuracy, being slow or time consuming, requiring high levels of skill or specialized knowledge, and being highly prone to error. An improved technique without such shortcomings is desired.

### SUMMARY OF THE INVENTION

The cross-image mapping (CIM) technique of the invention is designed to increase the ease, speed and accuracy of mapping objects across images for a variety of applications. These include—but are not limited to—flicker chronoscopy for medical tracking and diagnostic purposes, cartographic applications, tracking objects across multiple sequential images or video frames, and many others.

The CIM technique of the invention makes it possible to locate specific coordinates, objects or features in one image within the context of another. The CIM technique can be applied to any current or future imaging technology or representation, whether 2-D or 3-D, single-frame (still) images or multi-frame (video or other moving image types). The process can be easily automated, and can be applied in a variety of ways described below.

In an exemplary embodiment, the CIM technique of the invention generally employs three broad steps:

1. establishing a relationship between two images by morphing or, alternatively, mapping one or more images in a set to align them and to generate associated morphing or mapping parameters or, alternatively, to generate mapping parameters without first performing an alignment using a matching algorithm or manual mapping through a landmark tagging application such as those used in other contexts (e.g., photo morphing applications that transform one face into another);

2. establishing formulae for mapping from a given input image to a given aligned or unaligned output image or vice-versa; and

3. applying the mapping and/or alignment parameters to identify and highlight the pixel in one image corresponding to the comparable location in another (i.e., identify the pixel that shows the same location relative to some landmark in each image).

In the first step, actual morphing or modification of the images need not be applied if the landmark tagging is to or from an unaligned image rather than between aligned images. In such cases, the important output of an alignment algorithm is the formulae, not the modified images themselves.

The method may also include the ability to indicate the accuracy or reliability of mapped pixel locations. This accuracy or reliability assessment may be based on outputs or byproducts of the alignment algorithm(s) or tool(s) employed in the mapping, or on assessment of aligned images after the fact. Such accuracy or reliability measures may be presented in many ways, including but not limited to visual modification of the mapped marking (through modification of line thickness, color, or other attributes) and quantitative or qualitative indicators inside or outside of the image area (e.g., red/yellow/green or indexed metrics).

The scope of the invention includes a method, computer system and/or computer readable medium including software that implements a method for mapping images having a common landmark or common reference point (e.g., global positioning system tags, latitude/longitude data, and/or coordinate system data) therein so as to, for example, enable the creation, location and/or mapping of pixels, coordinates, markings, cursors, text and/or annotations across aligned and/or unaligned images. The computer-implemented method includes selecting at least two images having the common landmark or common reference point, mapping the selected images so as to generate mapping parameters that map a first location on a first image to the corresponding location of the first location on a second image, and identifying at least one pixel on the first image and applying the mapping parameters to at least one pixel on the first image to identify the corresponding pixel or pixels in the second image. The mapping parameters then may be used to locate or reproduce any pixels, coordinates, markings, cursors, text and/or annotations of the first image at the corresponding location of the second image.

In an exemplary embodiment, the two images may be of different image types including: x-ray image, photograph, line drawing, map image, satellite image, CAT image, magnetic resonance image, stereoscopic slides, video, and film. The images also may be taken from different perspectives and/or at different points in time. The images may be aligned using an automated image matching algorithm that aligns the first and second images and generates alignment parameters, or a user may manually align the first and second images by manipulating one or both images until they are aligned. Manual or automatic landmark mapping may also be used to identify the common landmark in the first and second images. In the case of automated landmark mapping, associated software may generate mapping parameters based on the locations in the first and second images of the common landmark. In addition, the first image may be morphed to the second image whereby the common landmark in each image has the same coordinates.

In the exemplary embodiment, an indication of a degree of accuracy of the alignment and/or mapping of the selected images at respective points in an output image may also be provided. Such indications may include means for visually distinguishing displayed pixels for different degrees of reliability of the alignment and/or mapping of the display pixels at respective points. For example, different colors or line thicknesses may be used in accordance with the degree of reliability of the alignment and/or mapping at the respective points or, alternatively, a numerical value for points on the output image pointed to by a user input device. The mapping may also be extended to pixels on at least one of the images that is outside of an area of overlap of the first and second images.

### BRIEF DESCRIPTION OF THE DRAWINGS

The foregoing summary, as well as the following detailed description of various embodiments of the present invention, will be better understood when read in conjunction with the appended drawings. For the purpose of illustrating the embodiments, there are shown in the drawings embodiments which are presently preferred. It should be understood, however, the embodiments of the present invention are not limited to the precise arrangements and instrumentalities shown.

FIG. 1 illustrates images of a single, unchanged object where unaligned image A illustrates the object as taken straight on from a specific number of feet and unaligned image B illustrates the same object from a lower vantage, further away, with the camera rotated relative to the horizon, and a different placement of the object in the image.

FIG. 2 illustrates how image B is modified to correspond to image A.

FIG. 3 illustrates the mapping parameters for mapping unaligned image B to unaligned image A.

FIG. 4a illustrates the mapping of a user-drawn circle at a user-defined location from the input image B to the output image (aligned image B or input image A).

FIG. 4b illustrates the application of alignment parameters (e.g. lines) to the images to indicate shift by mapping “before and after” marks from two or more images onto the marked images or other images from the image set.

FIG. 5 illustrates two types of images of the same object where common identifying features are provided in each image.

FIG. 6 illustrates the alignment of the images of FIG. 5 using a common feature by modifying one or more of the images to compensate for camera angle, etc. using a manual landmark application or an automated algorithm.

FIG. 7 illustrates the parameters for mapping from one image in a set to another, based on alignment of the two images (note the parameters are the same as in FIG. 3 except that the images are not aligned).

FIG. 8 illustrates the mapping of a user-entered input marking in image A to image B or aligned image B.

FIG. 9 illustrates an exemplary computer system for implementing the CIM technique of the invention.

FIG. 10 illustrates a flow diagram of the CIM software of the invention.

FIG. 11 illustrates the operation of a sample landmark tagging application in accordance with the invention whereby corresponding landmarks are identified in two images either manually or through automation.

FIG. 12 illustrates the expression of a given “location” or “reference point” in an image in terms of a common landmark or by using a convention such as the uppermost left-hand pixel in the overlapping area of aligned images.

FIG. 13 illustrates examples of displaying accuracy or reliability in the comparison of images using the CIM techniques of the invention.

FIG. 14 illustrates aligned and mapped images in which image A covers a small portion of the area covered by image B, and illustrates a means for identifying coordinates of a landmark in image B relative to image A coordinate system but beyond the area covered by image A.

### DETAILED DESCRIPTION OF ILLUSTRATIVE EMBODIMENTS

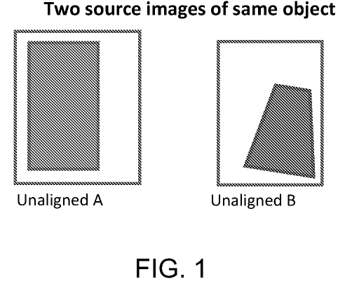

A detailed description of illustrative embodiments of the present invention will now be described with reference to FIGS. 1-14. Although this description provides a detailed example of possible implementations of the present invention, it should be noted that these details are intended to be exemplary and in no way delimit the scope of the invention.

### Overview

The CIM technique of the invention employs computer-enabled image morphing and alignment or, alternatively, mapping through landmark tagging or other techniques, as the basis of its capabilities. Specifically, two or more images are aligned and/or mapped to each other such that specific landmarks in either image fall in the same spot on the other. It is noted that the alignment may be of only part of each of the images. For example, the images may depict areas with very little common overlap, such as images of adjacent areas. In addition, one image may cover a small area included in a second, larger area covered by the second image. Thus, the landmarks or pixels shown in the overlap area, though bearing the same relationship to each other in both images and ostensibly representative of the same spot in space, might fall in very different locations within the image relative to the center, corner or edge. This alignment can be achieved by changing one image to match the other or by changing both to match a third, aligned image (in the case of multiple input images or video images, the same principles are applied several times over) or by mapping the images (mapping one image to match the other or by mapping both to match a third, aligned image) to each other without actually changing the images. There are currently several ways to do this using computers, including manual registration with image manipulation software such as Photoshop, or automatically, using technologies such as the Dual Bootstrap algorithm. However it is accomplished, the end result is (1) a set of images including two or more unaligned images (unaligned image A, unaligned image B, and so on) and two or more aligned images (aligned image A, aligned image B, and so on), such that the aligned images can be overlaid and only those landmarks that have moved or changed will appear in different pixel locations and/or (2) a set of parameters for mapping one or more image in the set to another such that this mapping could be used to achieve alignment as in (1). It is important to note that the CIM technique is indifferent to the mechanism used for aligning or mapping images and does not purport to accomplish the actual alignment of images.

As used herein, “aligning” means to transform a first image so that it overlays a second image. For example, image alignment may include the modification of one or more images to the best possible consistency in pixel dimensions (size and shape) and/or location of specified content within the image (e.g., where only part of images are aligned).

As used herein, “mapping” means to identify a mathematical relationship that can be used to identify spot or pixel in one image that corresponds to the spot or pixel in another image. It is not necessary to modify either image to establish mapping. For example, mapping is used to create alignment and/or to represent the operations performed to achieve alignment. Mapping parameters are the output of the mapping operation and are used to perform the calculations of pixel locations when performing landmark tagging.

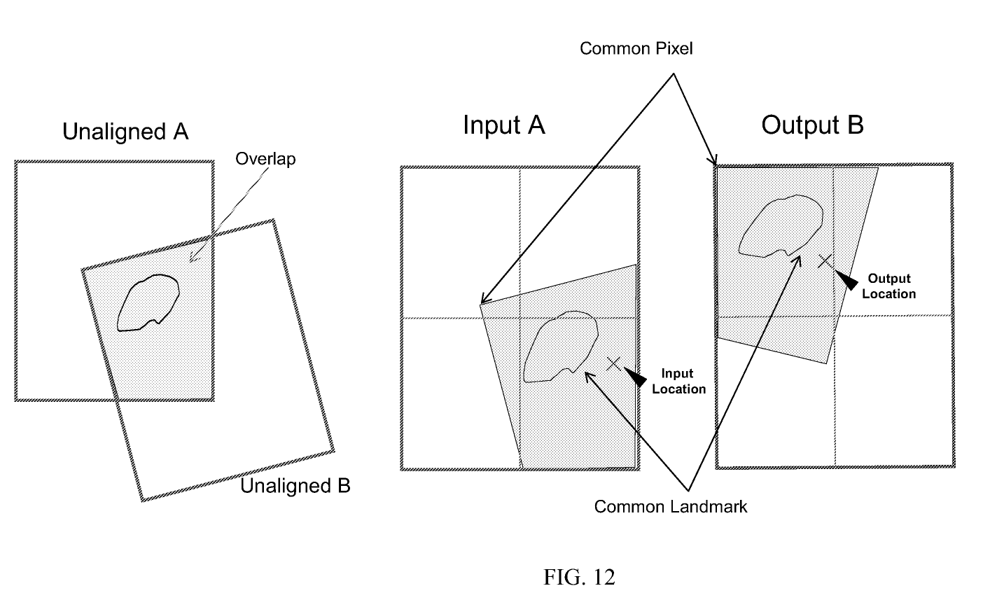

This technique applies equally well when, for example, the areas covered by two images result in only partial overlap as shown in FIG. 12. As illustrated in FIG. 12, a given “landmark” or “reference point” in an image is identified. In the mapped pair on the right, a specific location may be identified in either image relative to a common landmark, coordinate system, or according to mapping parameters, but falls in very different “locations” within the two images (as indicated by relative location to the lines bisecting each image). Depending on the mechanics of the alignment algorithm and/or the mapping parameters, this common pixel can be located in each image in any of several ways, typically (but not limited to) relative to a specified landmark or relative to a common reference point or pixel (e.g., uppermost left-hand) in the overlapping portion of the images.

As used herein, an “input image” is the image used to identify the pixel or location used for generating mapping, and an “output image” is the image upon which the mapped pixel or location is located and/or displayed. Both input and output images may be aligned or unaligned.

As used herein, “landmark tagging” refers to various forms of identifying common landmarks or registration points in unaligned images, either automatically (e.g. through shape recognition) or manually (i.e. user-identified).

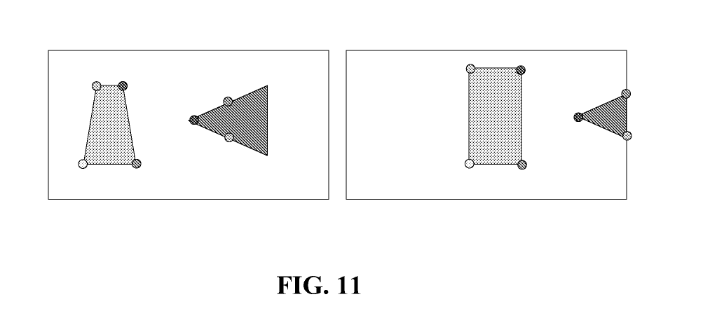

The CIM technique of the invention first creates formulae for mapping a specific location within any image in the input or aligned image sets to any other in the set. The formulae contain parameters for shifting image centers (or other reference point) up/down and left/right, rotating around a defined center point, stretching one or more axes or edges or dimensions to shift perspective, and so on. These formulae can (1) be captured as part of the output of automated alignment algorithms such as Dual Bootstrap, or (2) be calculated using landmark matching in a landmark tagging or other conventional application. As described below with respect to FIG. 11, the landmark tagging application will present the user with two or more images, allow the user to “tag” specific, multiple landmarks in each of the images, and use the resulting data to calculate the formulae or parameters that enable a computer program to map any given point in an image to the comparable point in another image within the set. Alternatively, landmark tagging may be achieved through automated processes using shape recognition, color or texture matching, or other current or future techniques.

Once the mapping formulae are established, the user selects two (or more) images from the image set for mapping. These may be all aligned images, a mix of unaligned and aligned images, or all unaligned images. These may be a mix of image types, for example drawings and photographs, 2-D video frames and 3-D still or moving renderings, etc. (e.g., CAT, MRI, stereoscopic slides, video, or film). The selected images are displayed by the landmark tagging application in any of several ways (e.g., side by side, or in overlapping tabs).

The user may then identify a pixel, feature or location in one of the selected images (the input image), and the CIM application will identify and indicate the corresponding pixel (same object, landmark or location) in the other selected images (output images). The manner of identification can be any of several, including clicking with a mouse or pointing device, drawing shapes, lines or other markings, drawing freehand with an appropriate pointing device, marking hard copies and scanning, or other computer input techniques. Selected pixels or landmarks can be identified with transient indicators, by translating the lines or shapes from the input image into corresponding display in the output image, or by returning coordinates in the output image in terms of pixel location or other coordinate system. The input image can be an unaligned or aligned image, and the output image(s) can also be either unaligned or aligned.

### Exemplary Embodiment

In accordance with an exemplary embodiment of the CIM process, two or more images are selected for mapping. These input images may have differences in perspective, camera angle, focal length or magnification, rotation, or position within a frame. In FIG. 1, illustrative images of a single, unchanged object are shown. In input image A, the object is shown as taken straight on from a specific distance (e.g., 6 feet), while input image B illustrates the same object from a lower vantage point, further away, with the camera rotated relative to the horizon, and a different placement of the object in the image. In some applications, the object will have changed shape, size, or position relative to other landmarks.

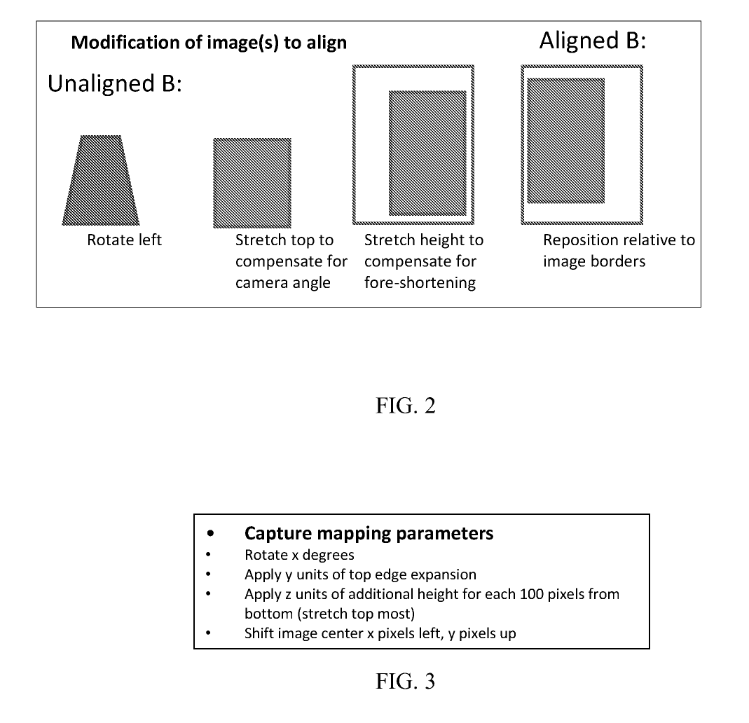

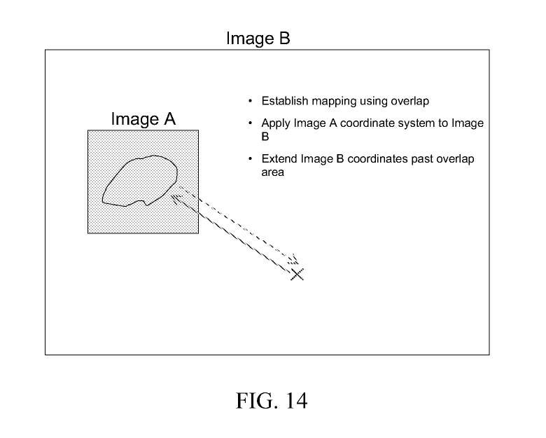

Parameters for aligning and/or mapping the images are calculated. If an automated matching/morphing algorithm such as Dual Bootstrap is used, this process is automated. Alternatively, if manual landmark tagging is used, the user identifies several distinctive landmarks in each image and “tags” them (e.g., see the triangles in FIG. 2). Finally, the images may be aligned through manual morphing/stretching (such as in Photoshop transforms). In either case, the best alignment or mapping possible is established. It is noted that, in some cases, some features may not align or map across images but that cross-image mapping may still be desirable. For example, there may have been structural change to the subject, such as altered pattern of blood vessels in retinal photographs, or there may be limited overlap between the areas covered in the images being mapped. In some cases, one image will be a subset of another. For example, a photograph of a small area of landscape may be mapped to a vector map covering a far larger area (e.g., see FIG. 14).

FIG. 2 shows how the input image B is modified to correspond to input image A. The resultant alignment and/or mapping parameters are recorded and translated into appropriate variables and/or formulae for aligning and/or mapping any two images in the image set. In the example of FIG. 3, the mapping parameters for mapping input image B to input image A are shown. Typically, these parameters are expressed as a series of mathematical equations.

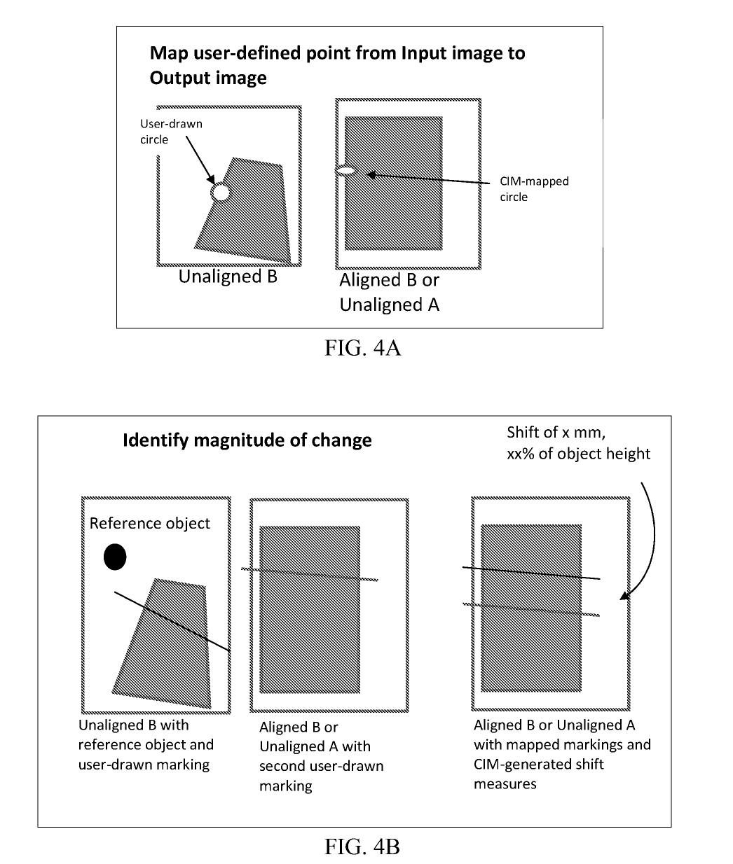

Alignment and/or mapping parameters are applied to align and/or map a location in one image to the equivalent location in another image within the image set. In FIG. 4a, a specific spot along the edge of a shape has been circled by the user, and the CIM application displays the equivalent shape on another image from the set (note that on the output image, the circle is foreshortened due to morphing for alignment). The item tagged may be a specific pixel, a circle or shape, or other form of annotation.

Alignment and/or mapping parameters also may be applied to indicate shift by mapping “before and after” marks from two or more images onto the marked images or other images from the image set. In FIG. 4b, two lines are drawn by the user (e.g., tracing the edge of a bone structure in an x-ray), and the two lines are plotted together onto a single image. It is noted that the image onto which the lines are plotted may be a third image from the same set and that more than two markings and/or more than two images may be used for this technique. In some applications, the drawing of the lines may be automated using edge detection or other techniques.

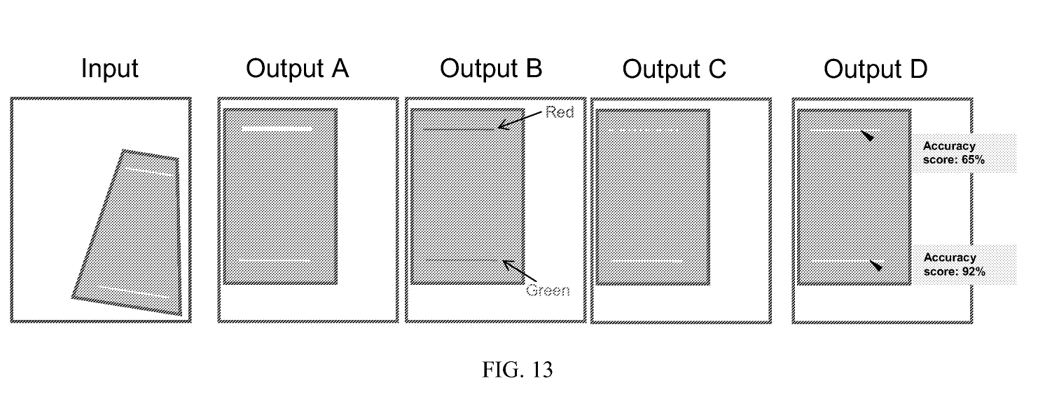

In FIG. 4b, the additional step of using a CIM-based calculation to quantify the shift between the two lines is shown. This distance can then be expressed as a percentage of the object's size (e.g., edge of bone has moved 15% of total distance from center), or in absolute measurement terms relative to an object of known size in the image, whether natural (e.g., distance between two joints) or introduced (e.g., steel ball introduced to one or more x-rays). Such quantification is described in more detail below in connection with FIG. 13.

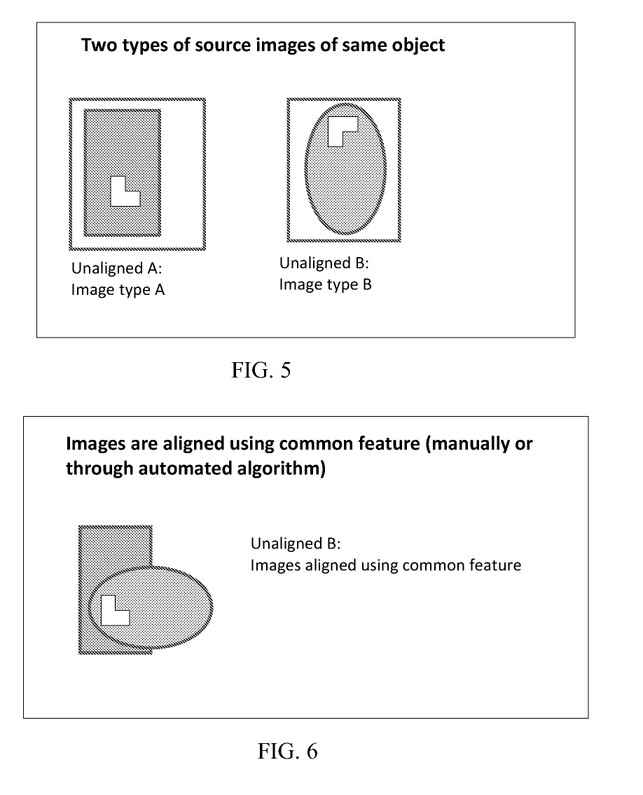

In another form of mapping, two images of different types may be used as input images, and a shared element of the two images may be used to calculate mapping parameters. Examples of this form include combining (1) x-rays and photos of tissue in the same spot, (2) photos and line maps or vector maps such as those used in Computer Aided Mapping (CAM) applications used to track water or electrical conduits beneath streets, (3) infrared and standard photographs, or (4) aerial or satellite photographs and assorted forms of a printed or computerized map. In this form of mapping, a common feature is used to align and/or map—and if necessary conform through morphing—two or more images. Examples of a common feature include: teeth visible in both a dental x-ray and a dental photograph; buildings visible in photographs and CAM maps; known coordinates in both images, e.g., a confluence of rivers or streets or latitude and longitude. For example, input image A in FIG. 5 may represent image type A such as an x-ray of teeth or a vector drawing such as in a CIM map. The illustrated white shape may be an identifying feature such as a tooth or a building. Input image B, on the other hand, may represent image type B such as a photo of tissue above an x-ray or an aerial photo of an area in a vector map. As in input image A, the white shape may be an identifying feature such as a tooth or building.

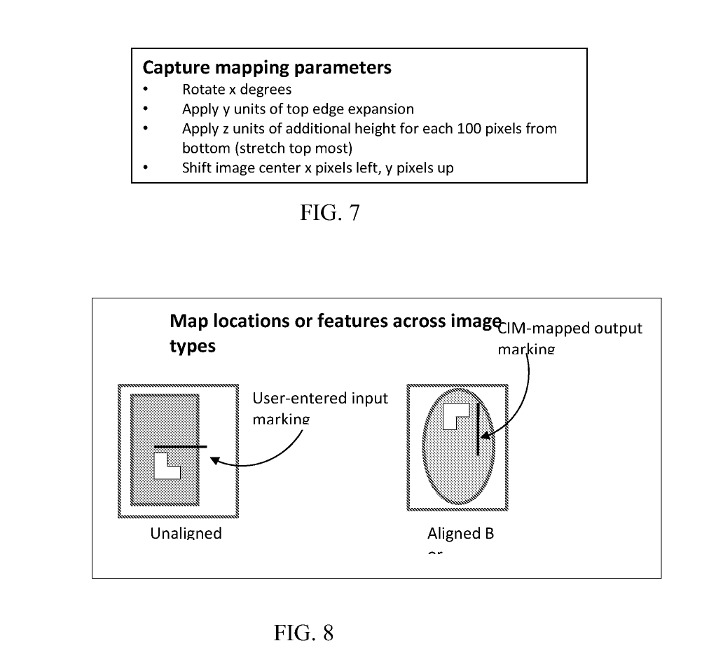

FIG. 6 illustrates the alignment of the input images using the common feature (e.g., tooth or building) by morphing one or more of the images to compensate for camera angle, etc. using a CIM landmark tagging application, an automated algorithm, or using manual alignment (e.g., moving the images around in Photoshop until they align). In some cases, alignment and/or mapping may be achieved automatically using shapes or other features common to both images (such as teeth in the above example). As in the form of landmark tagging described above with respect to FIGS. 2 and 3, the parameters for mapping from one image in a set to another are calculated and expressed as a series of mathematical equations as shown in FIGS. 3 and 7.

The resulting mapping capability can now be used to identify the location of a landmark or point of interest in one image within the area of another from the set. This is illustrated in FIG. 8, where a user-entered input marking in input image A is mapped to output image B using the techniques of the invention. If required, morphing of images may be applied in addition to re-orientation, x,y shift, rotation, and so on.

However, the mapping technique of the invention need not be limited to mapping visible markings It could, for instance, be used to translate cursor location when moving a cursor over one image to the mapped location in another image.

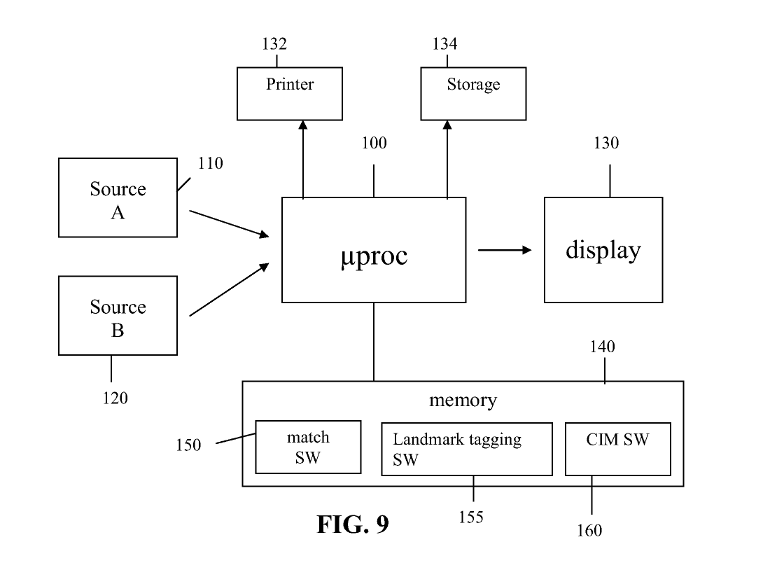

FIG. 9 illustrates an exemplary computer system for implementing the CIM technique of the invention. As shown, a microprocessor 100 receives two or more user-selected input images 110 and 120 and processes these images for display on display 130, printing on printer 132, and/or storage in electronic storage device 134. Memory 140 stores software including matching algorithm 150 and landmark tagging algorithm 155 that are optionally processed by microprocessor 100 for used in aligning the images and to generate and capture alignment parameters. Matching algorithm 150 and landmark tagging algorithm 155 may be selected from conventional algorithms known by those skilled in the art. CIM software 160 in accordance with the invention is also stored in memory 140 for processing by microprocessor 100.

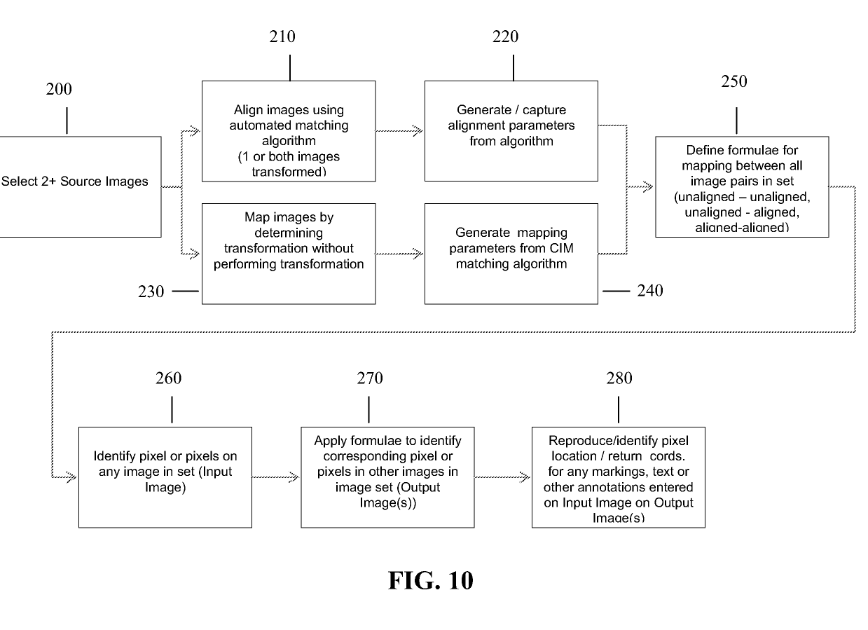

FIG. 10 illustrates a flow diagram of the CIM software 160 of the invention. As illustrated in FIG. 10, the CIM software 160 enables the user to select two or more images or portions of images at step 200. The selected images are then aligned in step 210 using the automated matching algorithm 150, and alignment parameters (e.g., FIG. 3) are generated/captured from the algorithm at step 220. The alignment may also be performed manually by allowing the user to manipulate, reorient and/or stretch one or both images until they are aligned. The mapping would document the manipulation and alignment parameters would be generated at step 220 based on the mapping documentation. On the other hand, landmark tagging (e.g., FIG. 11) also may be used to map images by determining transformations without changing the images at step 230 and generating the mapping parameters generated by the mapping application (e.g., CIM matching algorithm) at step 240. At step 250, the alignment and/or mapping parameters are used to define formulae for aligning/mapping between all image pairs in a set of images (e.g., unaligned-unaligned, unaligned-aligned, aligned-aligned). A pixel or pixels on any image in an image set (e.g., an input image) is then identified at step 260 and the afore-mentioned formulae are applied thereto to identify the corresponding pixel or pixels in other images in the image set (e.g., output images) at step 270. Finally, once the pixel location is mapped, any markings, text or other annotations entered on an input image are optionally reproduced on one or more output images, the pixel location is identified and/or displayed, and/or pixel coordinates are returned at step 280. Optionally, the degree of accuracy or reliability is calculated and/or displayed to user, as described below in connection with FIG. 13.

FIG. 11 illustrates a sample landmark mapping application used in step 230 in accordance with the invention in which the user selects two or more images that are displayed side-by-side, in a tabbed view, or in some other manner. The user selects landmarks such as corners of the same object in the two images and marks each landmark in each image using a mouse or other input device. The selected landmarks are identified as comparable locations in each image (e.g., by entering numbers or using a point-and-click interface). The CIM software 160 uses the corresponding points to calculate the best formulae for translation from one image to another, including x,y shift of the image(s), rotation, and stretching in one or more dimensions. The images need not be actually aligned; rather, the mapping formulae are used to map pixels, coordinates, markings, cursors, text, annotations, etc. from one image to another using the techniques described herein.

### Applications and Additional Embodiments

Additional levels of functionality may easily be added to the CIM software 160. For example, manual tagging or automated edge detection may be used to identify a specific landmark in two images, as well as a reference landmark of known size (e.g., a foreign object introduced into one image to establish a size reference) or location (e.g., the edge of a bone that has not changed). With this information, a CIM application or module within another application can calculate distances or percentage changes between two or more images.

Additional information about the mapping may be displayed visually or in other ways. For example, statistical measures of image fit may be used to estimate the accuracy and/or reliability of the mapping, and to display this degree of accuracy or “confidence range” through color, line thickness, quantitative displays or other means. Furthermore, such information may be a function of location within an image (e.g., along an edge that has been greatly stretched versus an edge that has not); these differences may be reflected in the display of such additional information either visually on an image (e.g., through line thickness or color of markings) or through representations such as quantitative measures. For example, when input images of greatly different coverage areas or resolution are used, a specific pixel in an input image may correspond to a larger number of pixels in the output image (for example, a ratio of 1 pixel to four). In this case, the line on the output image may be shown as four pixels wide for every pixel of width in the input image. Alternatively, this can be shown with colors, patterns or other visual indicators by, for example, showing less accurate location mappings in red instead of black, or dotted instead of solid lines. Similarly, when mapping from a higher-resolution input image to a lower resolution output image, the mapped locations might be one fourth the width; in this case, the line can be shown as using one quarter the pixel width, or as green, or as bold or double line.

This approach to showing accuracy of mapping can be based on factors other than resolution. For example, descriptive statistics characterizing the accuracy of alignment may be used, including measures derived from comparison of each pixel in an input and output image, measures derived from the number of iterations, processing time or other indications of “work” performed by the alignment algorithm, and so on. Such statistics may be employed as a measure of accuracy or fit. In another example, the uniformity of morphing applied can be used. For instance, if an image is stretched on one edge but not on another, the accuracy can be shown as greatest on the portion of the image that has been stretched the least. Similarly, any indication of accuracy of alignment, reliability of/confidence in an alignment or other qualifying measures may be used as the basis of indicating these confidence levels. In some implementations, it may be desirable to show the expected accuracy as a value or visual representation linked to the cursor (e.g., a tool-tip-like box that shows a numerical scale of alignment accuracy as the pointing device is moved around the image).

FIG. 13 illustrates examples of displaying accuracy or reliability as just described. In the example illustrated, the input image (on the left of the figure) requires more stretching on the top than the bottom. Thus, the mapping of pixels to the output image will be more accurate for the bottom line than the top line. As illustrated, this can be indicated through changes in the thickness of the line (Output A), the color of the line (Output B), attributes of the line (Output C), or by other, similar means. As also shown in FIG. 13, accuracy or reliability also may be indicated using a quantitative or qualitative display linked to the cursor, as in Output D. In this example, the cursor (triangle) is pointed at various locations in the image and a “score” showing accuracy or reliability of the alignment is shown for that location in the image.

Other location and coordinate mapping technologies may be integrated into the CIM techniques of the invention. For instance, when aligning vector maps and photographs, global positioning system (GPS) tags associated with one or the other may be used to identify common reference points in far larger images or in global information system (GIS) databases. This will allow rapid approximation of the overlapping areas and/or identify additional images to map, and can thus result in faster and more accurate mapping. Similarly, if one of the images in the image set includes or is associated with latitude and longitude data or coordinate data in another, this latitude/longitude or coordinate information may be mapped to other images in the image set using the CIM techniques described herein.

In an extension of the mapping of coordinates described above, coordinates may be extended beyond the area of overlap in the one or more images. For example, as illustrated in FIG. 14, if an image A has associated coordinate data attached but covers only a portion of the area covered by an image B that does not have coordinate data attached, the CIM technique of the invention may be used to infer the location of a pixel or object in image B based on extrapolation of coordinates attached to image A and mapped to image B using the overlapping area. FIG. 14 illustrates aligned and mapped images in which image A covers a small portion of the area covered by image B. Also, image A has associated coordinate data (e.g. latitude/longitude) and image B does not. A location in image B outside of the area of overlap with image A is selected as an input location, making image B the input image. The common landmark in the overlap area is at known coordinates in image A. Through CIM, the parameters for mapping the overlapped areas are known and by extension areas that do not overlap are known. This allows one to establish the location of any pixel in image B by (1) applying the image A coordinate data within the overlap area to image B within the overlap area, and (2) extending the mapping beyond the area of overlap to infer the coordinates within the image A coordinate system of a pixel in image B, even if it is outside of the area covered by image A. In this example, the output location cannot be shown on image A but can be expressed in the coordinate system applied to image A. With this method, CIM can be used to establish mappings outside the area of overlap.

The principles described herein may be applied in three dimensions as well as in two. For example, MRI, CT, stereoscopic photographs, various forms of 3-D video or other imaging types may all have CIM techniques applied to and between them. For example, an MRI and CT scan can be mapped using CIM techniques, allowing objects visible in one to be located within the other.

The structures that appear to have moved or changed in the respective input images may be located on the input images using the technique of the invention. Also, structures or baselines (e.g., jaw bone in dental images) may be established in historical unaligned or aligned images so as to show the change versus a current image. The technique may also be used to show corresponding internal and external features in images (e.g., abscesses on x-rays or gum surface in dental x-rays). This technique may also be used to show structures or baselines in successive frames of a video or other moving image source.

The principles described herein also may be applied to and between single-frame and multi-frame (video or other moving image formats) image types. For example, a frame from a video of a changing perspective (e.g., from a moving aircraft) may be aligned to a map or satellite image. Once landmark tagging has been established, a given object in the video may be tracked in subsequent frames of the video by applying landmark tagging or other techniques establishing mapping parameters to the subsequent frames of the video.

In yet another application, the CIM techniques described herein may be employed within a single moving image source by applying the technique to successive frames. For instance, a moving object in a video from a stationary perspective may be identified using landmark tagging or other techniques establishing mapping parameters and then tracked from frame to frame using successive applications of CIM. Alternatively, a stationary object in a video taken from a moving perspective (e.g., from an aircraft) may be tracked from frame to frame using landmark tagging or similar techniques.

Some example uses for CIM applications or CIM modules within other applications include:
Visual highlight of change in a medical or dental context. For example, a patient may be exhibiting jaw bone loss, a very common problem. Using CIM, the doctor may compare two or more dental x-rays of the same area of the patient's jaw taken months apart. By marking the bone line in one and using CIM to map this marking to other images, the doctor, patient or other parties can see how much the bone has moved during the period between image captures, thus quantifying both the pace and magnitude of change. Furthermore, the doctor could highlight the bone line along the top of the bottom jaw in each of the two images as well as a baseline (for example the bottom edge of the bottom jaw). The CIM application could then calculate bone loss as a percentage of total bone mass. Alternatively, a reference object could be included in one or more images, and the CIM application could then express bone loss in millimeters. These techniques are equally applicable to any form of x-ray of any body part or object.
Overlay of x-ray and photograph of same body part or other object. For example, a photograph of a patient's mouth and an x-ray of the same area can be aligned and/or mapped using teeth as a landmark. A CIM application could then be used to identify specific bone areas beneath the surface tissue shown in a photograph, or the specific tissue areas directly above specific bone areas. In another example, stress fractures visible in an aircraft wing's internal structure could be overlaid on a photograph of the exterior of the wing's surface, allowing precise location of the spot beneath which the fractures lie.
Overlay of a map or vector drawing and photograph. For example, a section of coastline in a satellite photograph could be mapped to and/or aligned with a map database using CIM applications. Another example: photographs of a sidewalk or street can be sent from a computer or phone or specialized device to a network-based application. This alignment could use manual identification of location or GPS coordinates to map the photograph to a specific section of a GIS database or other database containing precise information about the location of pipes, electrical conduits, etc. Once mapped, the location of pipes or conduits beneath the pavement can be shown exactly on the original photograph, eliminating the need for surveying equipment.

Examples of how this technique might be employed include using the overlay of a CIM map of gas mains and an aerial photo of a city block to pinpoint a location for digging which can be found by workers using landmarks rather than surveying equipment. In this example, GPS coordinates associated with one or both images may be used to identify additional images or areas of images contained in databases with which to align. This application can also use various measures of the accuracy and precision of alignment to indicate precision of mapping. The technique may also be used to examine the bones underneath a specific area of inflamed tissue or to locate a specific object visible in one photograph by mapping it against a shared feature in a map or alternate photograph.

In the example CIM applications above, the input (pointing) can take a variety of forms. Input mechanisms include (1) drawing lines, shapes or other markings using a mouse, touch-screen or other input device, so they are visible on the input image, (2) drawing lines, shapes or other markings using a mouse, touch-screen or other input device so they are not visible on the input image, (3) entering coordinate data such as latitude/longitude or map grids, such that specific pixels are identified on an input image with such associated coordinates, or (4) entering other types of information associated with specific locations within an image. Examples of other types of information include altitude data on a topographical map or population density in a map or other database. In these examples, the form of input could be to specify all areas corresponding to a specific altitude or range of altitudes, or to a specific population density or range of population densities. Other means of input, either existing or invented in the future, may be used to achieve the same result.

Similarly, in the example CIM applications above, the output (mapping/indicating) can take a variety of forms. These include (1) showing lines, shapes or other markings on the output image, (2) returning the pixel location(s) of corresponding pixels in the output image, (3) returning latitude and longitude or other coordinates associated with pixels or specific locations in the output image, and (4) other forms of information associated with specific locations within an image.

Furthermore, some input or output methods do not require the display of one or both images to be effective. For instance, when using a map or satellite image which has associated coordinate data as an input image, the location to be mapped may be indicated by inputting appropriate coordinates, or alternatively values such as altitude ranges or population densities even if the input image is not displayed. These locations may then be displayed or otherwise identified or indicated in the output image. Similarly, when an output image with associated coordinate data is used, these coordinates can be identified or returned, without the output image itself being displayed.

The user may then identify a feature or location in one of the selected images (the input image), and the CIM application will identify and indicate the corresponding pixel (same object, landmark or location) in a second selected image (output image). The manner of identification may be any of several, as described above. Selected pixels or landmarks may be identified with transient indicators or by translating the lines or shapes from the input image into corresponding display in the output image, or by returning coordinates or other location indicators in the output image. The input image may be either an aligned or unaligned image, and the output image(s) also may be either an unaligned or aligned image.

Those skilled in the art also will readily appreciate that many additional modifications are possible in the exemplary embodiment without materially departing from the novel teachings and advantages of the invention. For example, those skilled in the art will appreciate that the methods of the invention may be implemented in software instructions that are stored on a computer readable medium for implementation in a processor when the instructions are read by the processor. Accordingly, any such modifications are intended to be included within the scope of this invention as defined by the following exemplary claims.

1-48. (canceled)

49. A method for mapping images having a common landmark or common reference point therein, comprising the steps of:
selecting at least two images having said common landmark or said common reference point;
mapping the selected images so as to generate mapping parameters that map a first location on a first image to the corresponding location of the first location on a second image; and
identifying at least one pixel on the first image and applying said mapping parameters to said at least one pixel on said first image to identify the corresponding pixel or pixels in said second image.

50. A method as in claim 49, further comprising using said mapping parameters to locate or reproduce any pixels, coordinates, markings, cursor, text and/or annotations of said first image at the corresponding location of said second image.

51. A method as in claim 49, wherein said at least two images are of different image types including at least two of the following: x-ray image, photograph, line drawing, map image, satellite image, CAT image, magnetic resonance image, stereoscopic slides, video, and film.

52. A method as in claim 51, wherein said at least two images are taken from different perspectives and/or at different points in time.

53. A method as in claim 49, wherein said mapping step comprises aligning the first and second images manually by allowing the user to manipulate, reorient and/or stretch one or both images until they are aligned and generating alignment parameters reflecting the manipulation, reorientation, and/or stretching used to align the first and second images.

54. A method as in claim 49, wherein said mapping step comprises aligning the first and second images using an automated image matching algorithm and generating alignment parameters.

55. A method as in claim 49, wherein said mapping step comprises manually identifying said common landmark in said first and second images and generating said mapping parameters.

56. A method as in claim 49, wherein said mapping step comprises using automated tools to identify said common landmark in said first and second images and to generate said mapping parameters.

57. A method as in claim 49, wherein the mapping parameters define formulae for mapping corresponding image pixels between said first and second images.

58. A method as in claim 49, wherein said mapping step comprises morphing the first image to the second image whereby the common landmark in each image has the same coordinates.

59. A method as in claim 49, wherein said common reference point comprises global positioning system tags, latitude/longitude data, and/or coordinate system data.

60. A method as in claim 49, wherein said mapping step comprises applying said mapping parameters to pixels on at least one of said images that is outside of an area of overlap of said first and second images.

61. A computer system adapted to map images having a common landmark or common reference point therein, comprising:
a processor;
a display; and
a memory that stores instructions for processing by said processor, said instructions when processed by said processor causing said processor to:
enable a user to select at least two images having said common landmark or said common reference point;
map the selected images so as to generate mapping parameters that map a first location on a first image to the corresponding location of the first location on a second image; and
identify at least one pixel on the first image and to apply said mapping parameters to said at least one pixel on said first image to identify the corresponding pixel or pixels in said second image.

62. A computer system as in claim 61, wherein said processor further uses said mapping parameters to locate or reproduce any pixels, coordinates, markings, cursor, text and/or annotations of said first image at the corresponding location of said second image.

63. A computer system as in claim 61, wherein said at least two images are of different image types including at least two of the following: x-ray image, photograph, line drawing, map image, satellite image, CAT image, magnetic resonance image, stereoscopic slides, video, and film.

64. A computer system as in claim 63, wherein said at least two images are taken from different perspectives and/or at different points in time.

65. A computer system as in claim 61, wherein said instructions include instructions that enable a user to manually align the first and second images by allowing the user to manipulate, reorient and/or stretch one or both images until they are aligned and that generate alignment parameters reflecting the manipulation, reorientation, and/or stretching used to align the first and second images.

66. A computer system as in claim 61, wherein said instructions include an automated image matching algorithm that causes said processor to align the first and second images and to generate alignment parameters.

67. A computer system as in claim 61, wherein said instructions include instructions that when processed by said processor enable a user to manually identify said common landmark in said first and second images and that generate mapping parameters based on the locations in the first and second images of the common landmark.

68. A computer system as in claim 61, further comprising automated tools that identify said common landmark in said first and second images and generate said mapping parameters.

69. A computer system as in claim 61, wherein said instructions include instructions that when processed by said processor cause said processor to generate mathematical formulae for mapping corresponding image pixels between said first and second images.

70. A computer system as in claim 61, wherein said instructions include instructions that when processed by said processor causes the first image to be morphed to the second image whereby the common landmark in each image has the same coordinates.

71. A computer system as in claim 61, wherein said common reference point comprises global positioning system tags, latitude/longitude data, and/or coordinate system data.

72. A computer system as in claim 61, wherein said instructions include instructions for applying said mapping parameters to pixels on at least one of said images that is outside of an area of overlap of said first and second images.

73. A non-transitory computer readable storage medium including instructions stored thereon that when processed by a processor causes said processor to map images having a common landmark or common reference point therein, said instructions comprising instructions that cause said processor to perform the steps of:
selecting at least two images having said common landmark or common reference point;
mapping the selected images so as to generate mapping parameters that map a first location on a first image to the corresponding location of the first location on a second image; and
identifying at least one pixel on the first image and applying said mapping parameters to said at least one pixel on said first image to identify the corresponding pixel or pixels in said second image.

74. A storage medium as in claim 73 wherein said instructions further include instructions that use said mapping parameters to locate or reproduce any pixels, coordinates, markings, cursor, text and/or annotations of said first image at the corresponding location of said second image.

75. A storage medium as in claim 73, wherein said at least two images are of different image types including at least two of the following: x-ray image, photograph, line drawing, map image, satellite image, CAT image, magnetic resonance image, stereoscopic slides, video, and film.

76. A storage medium as in claim 75, wherein said at least two images are taken from different perspectives and/or at different points in time.

77. A storage medium as in claim 73, wherein said instructions include instructions that enable a user to manually align the first and second images by allowing the user to manipulate, reorient and/or stretch one or both images until they are aligned and that generate alignment parameters reflecting the manipulation, reorientation, and/or stretching used to align the first and second images.

78. A storage medium as in claim 73, wherein said instructions include an automated image matching algorithm that causes said processor to align the first and second images and to generate alignment parameters.

79. A storage medium as in claim 73, wherein said instructions include instructions that when processed by said processor enable a user to manually identify said common landmark in said first and second images and that generate mapping parameters based on the locations in the first and second images of the common landmark.

80. A storage medium as in claim 73, wherein said instructions include automated tools that identify said common landmark in said first and second images and that generate said mapping parameters.

81. A storage medium as in claim 73, wherein said instructions cause the processor to generate mathematical formulae for mapping corresponding image pixels between said first and second images.

82. A storage medium as in claim 73, wherein said instructions include instructions that when processed by said processor causes the first image to be morphed to the second image whereby the common landmark in each image has the same coordinates.

83. A storage medium as in claim 73, wherein said instructions include instructions for applying said mapping parameters to pixels on at least one of said images that is outside of an area of overlap of said first and second images.
